(19) United States
(12) Patent Application Publication
(10) Pub. No.: US 2003/0027524 A1
(43) Pub. Date: Feb. 6, 2003

(54) Mobile communication network forming device, mobile communication system, mobile communication network forming method, program and computer-readable storage medium

(75) Inventors: Hisashi Matsuoka, Yokohama-shi (JP); Masaaki Yoshimi, Fujisawa-shi (JP); Kazumasa Nitta, Yokosuka-shi (JP); Takashi Ono, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: NTT DoCoMo, Inc., Tokyo (JP)

(21) Appl. No.: 10/196,191

(22) Filed: Jul. 17, 2002

(30) Foreign Application Priority Data
Jul. 17, 2001 (JP) P2001-216953

(51) Int. Cl. H04B 7/185

(52) U.S. Cl. 455/13.1; 455/427; 455/12.1

(57) ABSTRACT

A mobile communication network forming device of the present invention comprises: a base station function section that forms a wireless zone, subscriber switching means that chiefly perform in-range management of mobile stations that are in range of the wireless zone and connection exchange between mobile stations that are in range of the wireless zone, and satellite gateway switching means that perform mutual connection between a mobile station which is in range of a wireless zone and other communication network through a communication satellite.

### BACKGROUND OF THE INVENTION

1. Field of the Invention

The present invention relates to a mobile communication network forming device etc, which provides a mobile communication service in the specified wireless zone.

2. Related Background Art

Mobile communication systems enabling connection of a satellite zone with comparatively low subscriber density to a mobile communication network have previously been proposed, for example in Japanese Patent Laid-open H. 9-219881. According to this system, even in case where it is difficult to install a leased line, a service area can be expanded by arranging a base station in satellite zones where no mobile communication service is provided, and connecting such base station to the existing switch network using an entrance device (ground-based or satellite wireless line) that performs communication using microwaves.

However, a system as described above is problematic in that since even in the case of communication between the mobile stations both of which are under the control of the base station the signals for such communication go through the satellite entrance line, heavy traffic is generated on the satellite entrance line.

For solving above-mentioned problem, it is an object of the present invention to provide a mobile communication network forming device etc, which can reduce the traffic volume generated on the satellite entrance line.

### SUMMARY OF THE INVENTION

In order to achieve the above object, a device of the present invention comprises the following means. Specifically, a base station function section that forms a wireless zone, subscriber switching means that perform connection exchange between mobile stations that are in range in said wireless zone and in-range management of mobile stations that are in range in said wireless zone, and satellite gateway switching means that perform mutual connection between other communication network and a mobile station that is in range in said wireless zone through a communication satellite.

Since a base station function and subscriber switching function are provided, the communication area is expanded and communication between mobile stations that are under the control of this device can be achieved without going through the satellite entrance line, thereby reducing the traffic volume generated on the satellite entrance line.

In order to achieve the above object, a method of the present invention comprises the following steps. Specifically, a connection request acceptance step accepting from a mobile station in range of a wireless zone formed by a base station function section of a mobile communication network forming device a connection request for requesting connection with other communication terminal, in-range determination step determining whether said other communication terminal is in range of said wireless zone or not, and a connection execution step executing the connection between said mobile station and said other communication terminal using a subscriber switching means in case said other communication terminal is determined to be in range of said wireless zone in said in-range determination step, and executing the mutual connection between said mobile station and other communication network via a communication satellite in case said other communication terminal is determined to be not in range of said wireless zone in said in-range determination step.

An execution of the mutual connection between the mobile station and other communication network via the communication satellite enable the formation of local mobile communication area in the region which is not covered by existing communication network. On the other hand, since in case the communication terminal which is a connection destination is in range of the wireless zone formed by the mobile communication network forming device the connection between the mobile station and the relevant communication terminal is executed by the subscriber stitching means of the mobile communication network forming device, the communication between mobile stations which are under the control of the mobile communication network forming device without going through the communication satellite becomes possible, thereby reducing the traffic volume generated on the satellite entrance line.

### BRIEF DESCRIPTION OF THE DRAWINGS

FIG. 1 is a view illustrating the concept of a mobile communication system according to an embodiment of the present invention;

FIG. 2 is a view illustrating the structure of a mobile communication system according to an embodiment of the present invention;

FIG. 3 is a view illustrating the structure of mobile communication network forming device 10;

FIG. 4 is a sequence chart illustrating the operation relating to position registration of a mobile station;

FIG. 5 is a sequence chart illustrating the operation relating to call origination;

FIG. 6 is a sequence chart illustrating the operation relating to call termination;

FIG. 7 is a sequence chart relating to communication between terminals under the control of local mobile telephone network 50; and

FIG. 8 is a sequence chart relating to disconnection processing and charging processing.

### DESCRIPTION OF THE PREFERRED EMBODIMENTS

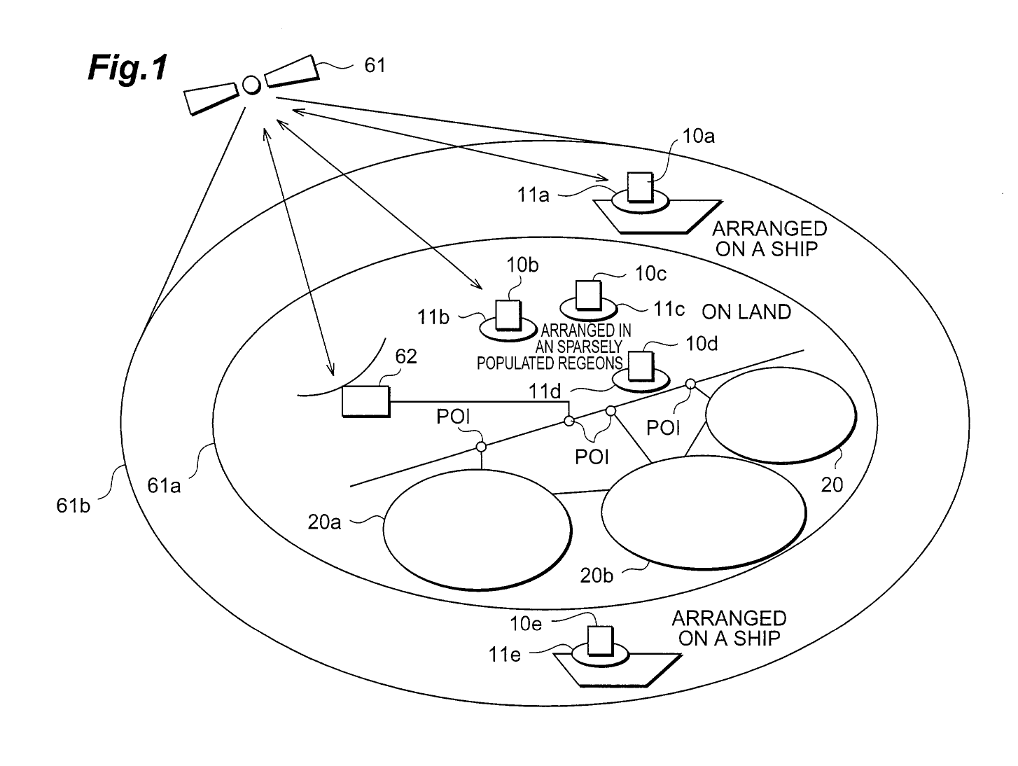

FIG. 1 is a view illustrating the concept of a mobile communication system according to an embodiment of the present invention. In this embodiment, devices 10a to 10e and a ground-based mobile communication network 20, each forming a mobile communication network, are provided by the same specified communication service provider. Mobile communication network forming devices 10a to 10e form respective wireless zones 11a to 11e and provide mobile communication service for the mobile stations under their control. Since mobile communication network forming devices 10a to 10e have a gateway switching function, they can be installed in any location so long as a drive power source is available. For example, as in the case of mobile communication network forming devices 10a and 10e, they could be installed on ships which are at anchor at sea or in motion at sea, where wired connection with an switch network is difficult. Also, as in the case of mobile communication network forming devices 10b to 10d, they could be installed in sparsely populated regions and a mobile communication service is not previously provided.

Since mobile communication network forming devices 10a to 10e have a base station function and subscriber system switching function, they form a local mobile communication network. And also, communication between mobile stations under their control thus becomes possible. In this case, the user signals do not pass through the satellite entrance line. Moreover, service control, call control, various types of signal processing and the charging count etc in respect of the mobiles are independently performed by each of the mobile communication network forming devices 10a to 10e.

Also, since mobile communication network forming devices 10a to 10e have a satellite communication function and gateway switching function, communication between mobile stations under their control and other communication networks is possible. In this connection, “other communication networks” is defined as following; Firstly, (1) a communication network provided by the aforementioned specified communication service provider, wherein in order to perform communication therewith, it is necessary to pass through a point of interface (hereinbelow termed “POI”); and secondly, (2) communication networks provided by communication service providers other than the aforementioned specified communication service provider, to which roaming is possible irrespective of the communication method employed. For example, the ground-based communication network 20 corresponds to other communication network of (1) for communication network forming device 10a. And, a mobile communication network 20a provided by other communication service provider (other company) and a fixed line communication network 20b provided by other company corresponds to other communication network of (2) for mobile communication network forming device 10a. The other communication networks are not restricted to this communication system and could be for example W-CDMA or PDC or fixed line networks.

As shown in FIG. 1, communication satellite 61 covers a sea area 61b as well as a land area 61a. Mobile communication network forming devices 10a to 10e that are arranged in sea area 61b are connected with the POI through a satellite entrance line. That is, the wireless signals sent from mobile communication network forming devices 10a to 10e are received by ground-based satellite base station 62 through communication satellite 61 and sent to the POI. Also, the signals sent from ground-based mobile communication network 20, mobile communication network 20a provided by other company or fixed line communication network 20b provided by other company are transmitted to mobile communication network forming devices 10a to 10e through the POI, ground-based satellite base station 62 and communication satellite 61.

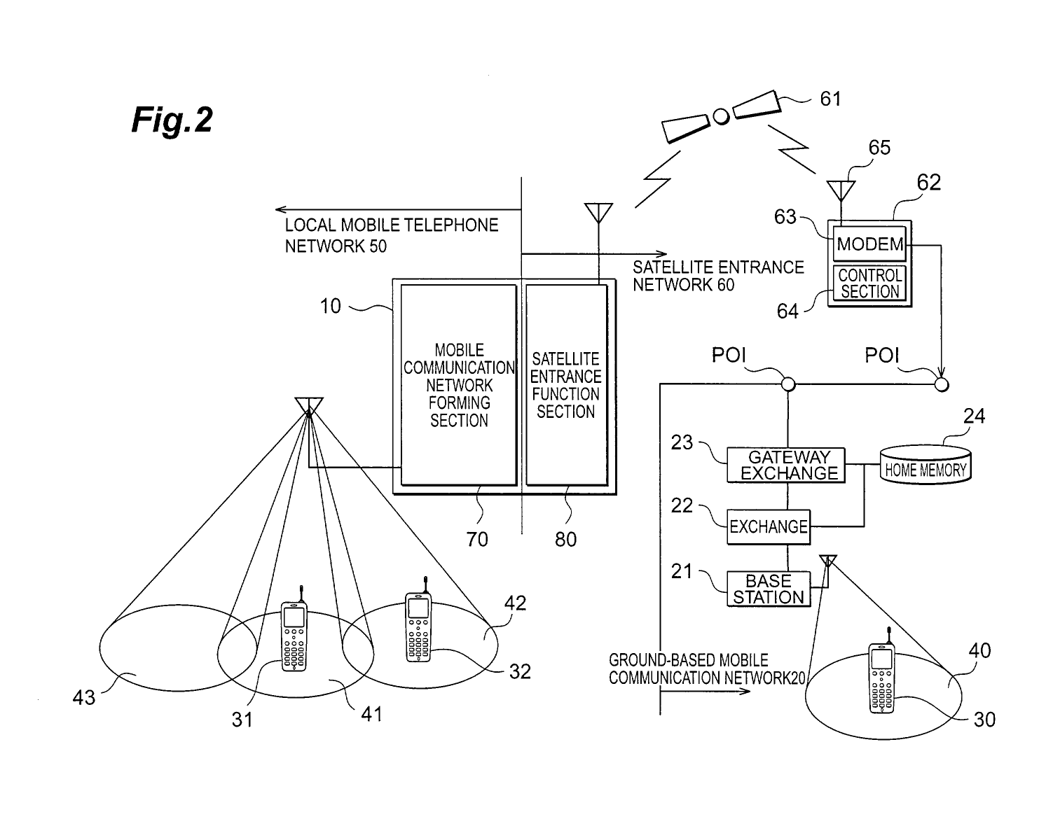

FIG. 2 is a view illustrating the structure of a mobile communication system according to an embodiment of the present invention. Ground-based communication network 20 is a network that provides mobile communication service and is constituted by a base station 21 forming a wireless zone, subscriber-based exchange 22 that performs service control, call control, various types of signal processing and charging, and gateway exchange 23 that performs mutual connection with other networks. Home memory 24 stores subscriber information and the registration information of mobile stations 30 to 32.

Mobile stations 30 to 32 are provided communication service by the specified communication service provider, which operates local mobile telephone network 50 formed by a mobile communication network forming section 70 of a mobile communication network forming device 10 and ground-based mobile communication network 20.

Mobile communication network forming device 10 comprises mobile communication network forming section 70 that provides mobile communications service to mobile stations 31 and 32 and satellite entrance function section 80 that realizes satellite entrance for connection with the POI. Mobile communication network forming section 70 forms zones 41 to 43, in which mobile stations 31 and 32 can receive mobile communication services. Satellite entrance function section 80 performs satellite communication with ground-based satellite base station 62 through communication satellite 61.

Ground-based satellite base station 62 comprises an antenna 65 that sends and receives signals, a modem 63 that performs modulation and demodulation of signals and a control section 64 that performs satellite wireless line control and is connected with the POI through a leased line. Ground-based satellite base station 62 receives signals transmitted from satellite entrance function section 80 through communications satellite 61 and transmits these to the POI. It also receives signals from the POI and sends these to the satellite entrance function section 80 through communication satellite 61.

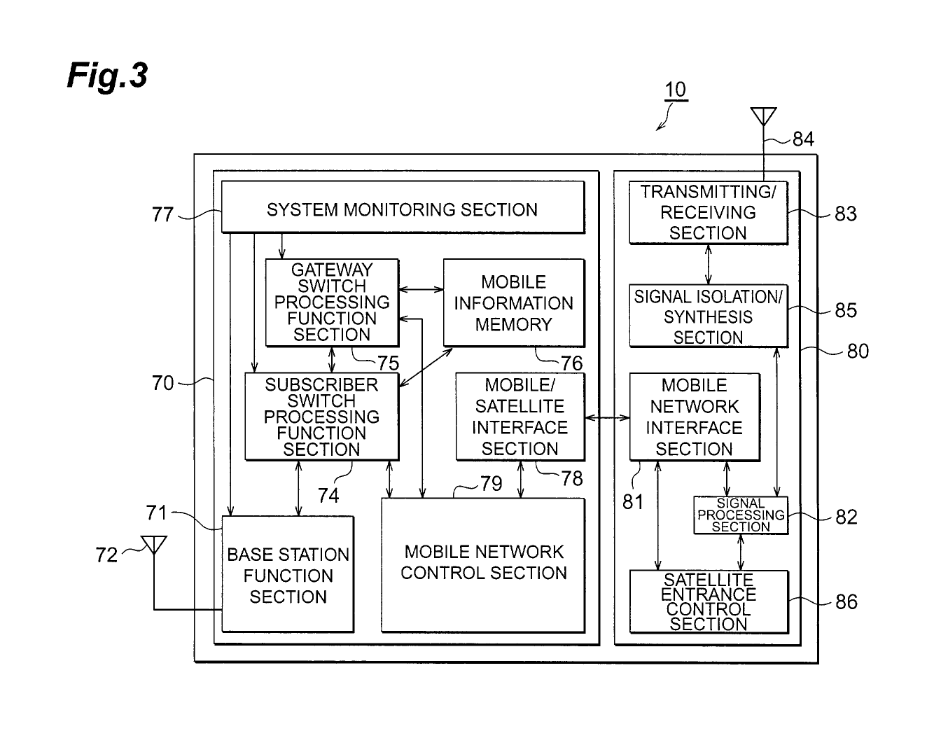

FIG. 3 is a view showing the structure of a mobile communication network forming device 10. In mobile communication network forming section 70, base station function section 71 forms zones 41 to 43 and performs transmission and reception of signals, modulation and demodulation, and wireless management. Antenna section 72 exchanges electromagnetic waves with mobile stations 31 and 32. Subscriber switch processing function section 74 performs management, including in-range management, such as service control, call control, various types of signal processing and charging counting. In this invention, “in-range management ” indicates the management to determine whether a mobile station is in range of the wireless zone formed by the mobile communication network forming device or not. Gateway switch processing function section 75 performs signal processing when mutual connection is performed with other network. Mobile information memory 76 stores the registration information and subscriber information of mobile stations 31 and 32. System monitoring section 77 performs monitoring of the entire local mobile telephone network 50. Mobile/satellite interface section 78 performs signal reception and transmission with the satellite entrance function section 80 upon communication via the satellite. Mobile network control section 79 controls transmission of various types of signals in base station function section 71, subscriber switch processing function section 74, gateway switch processing function section 75, mobile in formation memory 76 and mobile/satellite interface section 78. By means of the above, mobile communication network forming section 70 provides the same service to mobile stations 31 and 32 as does ground-based mobile communication network 20.

When mobile stations 31, 32 perform communication with other network, satellite entrance function section 80 has the function of performing transmission of information to and from ground-based satellite base station 62 via communication satellite 61 in order to connect with the POI using satellite entrance network 60. It also transmits a roaming signal for connection with the other network, a user signal and information of mobiles that are within range in local mobile telephone network 50. Mobile network interface section 81 serves as a signal transmission interface with mobile communication network forming section 70. A signal processing section 82 performs processing of signals from mobile communication network forming section 70 and signals from the satellite line. A transmission/reception section 83 performs transmission/reception of signals to/from the satellite through a satellite antenna section 84. A signal isolation/synthesizing section 85 performs signal isolation and synthesis. A satellite entrance control section 86 performs control of the entire satellite entrance function section 80.

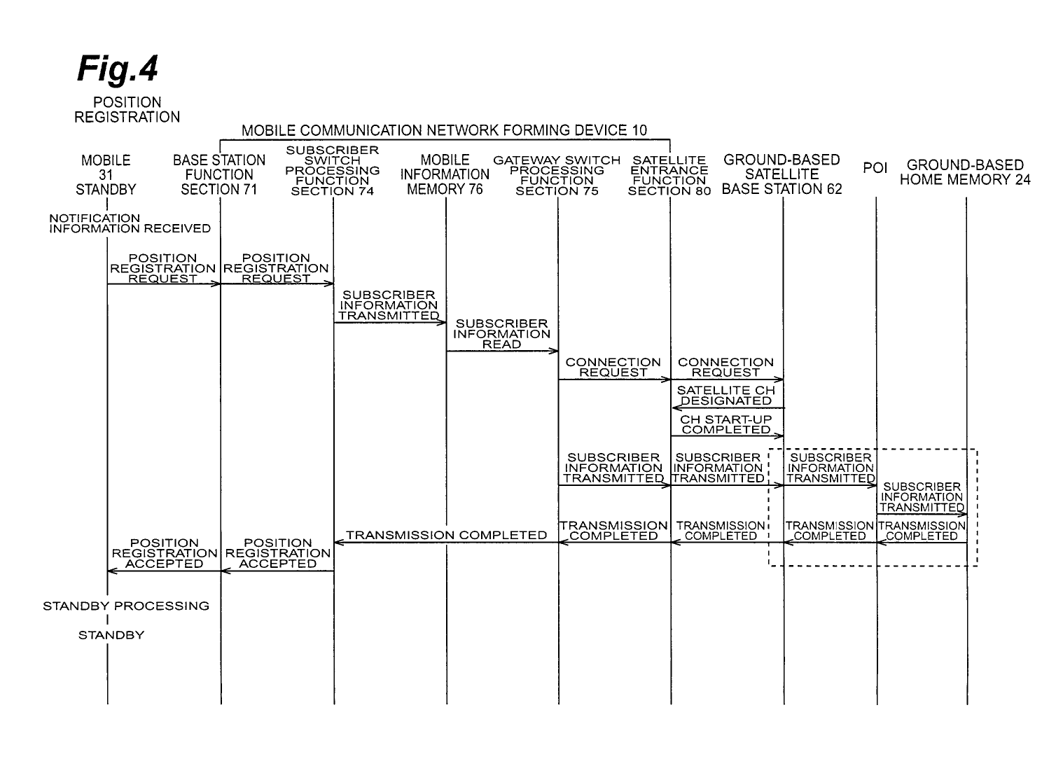

Next, the operation of a mobile communication system according to the embodiment of the present invention constructed as above will be described. FIG. 4 is a sequence chart showing the operation relating to position registration of a mobile station. When a mobile station 31 is in standby mode in zone 40 in ground-based mobile communication network 20, the information that it is within range is registered in home memory 24 as registration information. Here, it is assumed that mobile station 31 has moved out of range of zone 40, which is the service area of ground-based mobile communication network 20, into zone 41 which is formed by mobile communication network forming device 10. In zone 41, upon received notification information mobile station 31 transmits a signal requesting position registration to mobile communication network forming device 10. The position registration request signal sent from mobile station 31 is transferred to base station function section 71 and subscriber switch processing function section 74. Gateway switch processing function section 75 then stores the information of mobile station 31 in mobile information memory 76.

Gateway switch processing function section 75 makes a connection request to satellite entrance function section 80 after reading the subscriber information from mobile information memory 76. When mobile network control section 79 recognizes that gateway switch processing function section 75 has transmitted a connection request signal, it starts up mobile/satellite interface section 78, causing a signal requesting connection with the satellite entrance line to be sent to mobile network interface section 81 of satellite entrance function section 80. When satellite entrance control section 86 monitoring mobile network interface section 81, receives a connection request signal from mobile network interface section 81, it transmits a connection request signal to communication satellite 61 through signal processing section 82, signal isolation/synthesis section 85, transmission/reception section 83 and satellite antenna section 84.

When ground-based satellite base station 62 receives the connection request signal relayed by communication satellite 61, it specifies a wireless channel in the satellite zone by means of instructions from control section 64. After satellite entrance function section 80 has established synchronization of the specified wireless channel, it returns “satellite channel start-up completed” to ground-based satellite base station 62. Gateway switch processing function section 75 transfers the subscriber information ant the registration information to ground-based satellite base station 62 through satellite entrance function section 80. That is, it notifies the ground-based home memory 24 of the specified communications service provider that is nearest to the POI, using the satellite entrance line, of the fact that mobile station 31 is in range in the zone 41 formed by mobile communication network forming device 10. Connection of an incoming call with mobile station 31 thereby becomes possible. Note that a substitution could be made by installing a control section and home memory corresponding to ground-based home memory 24 in control section 64 in ground-based satellite base station 62. After completion of communication as above, position registration is completed and mobile station 31 performs standby processing.

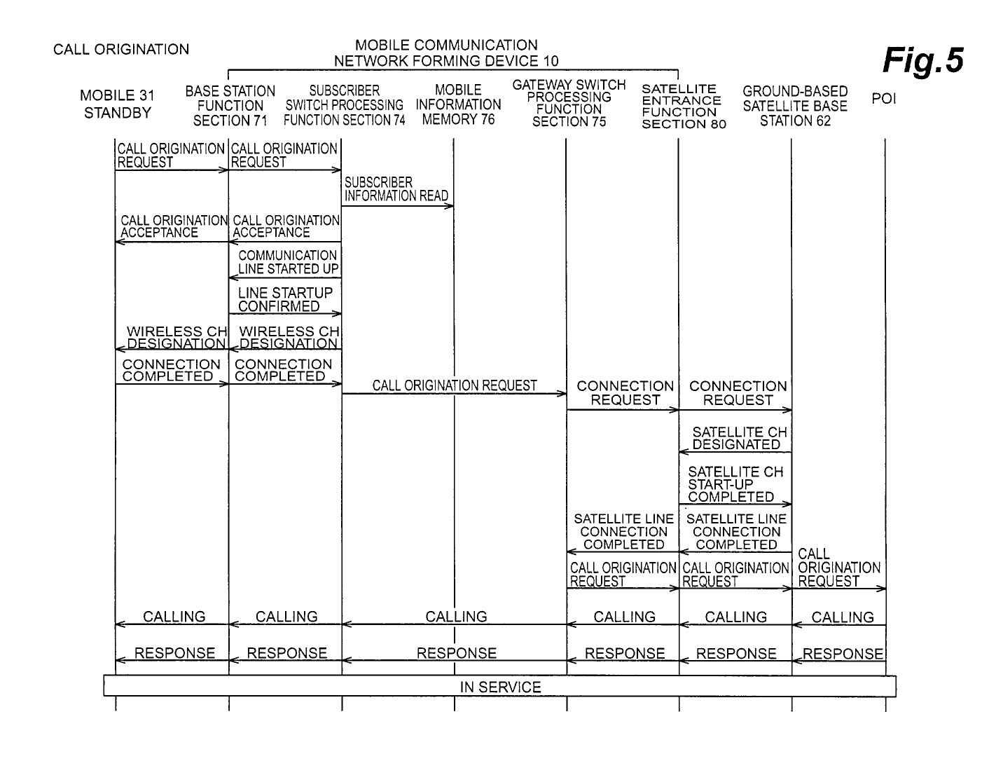

Next, the case will be described where mobile station 31 performs call origination to a terminal under the control of mobile communication network 20a provided by other company, fixed communication network 20b provided by other company or ground-based mobile communication network 20 which is a communication network of the specified communication service provider. FIG. 5 is a sequence chart showing the operation relating to call origination. Mobile station 31 which is in standby in the range of local mobile telephone network 50 sends a call origination request signal to base station function section 71. Base station function section 71 transmits the call origination request signal to subscriber switch processing function section 74. Subscriber switch processing function section 74 reads the information relating to the mobile station 31 from mobile information memory 76 and if it determines that communication is possible returns a call origination acceptance signal to mobile station 31 through base station function section 71. It also sends a signal for starting up the communication line to base station function section 71. Base station function section 71 determines a frequency band capable of being used in zone 41 and starts up a communication line, thereafter returns confirmation of line start-up to the subscriber switch processing function section 74.

If subscriber switch processing function section 74 determines that the line connection destination of the call origination request from mobile station 31 is a mobile communication network 20a provided by other company, a fixed communication network 20b provided by other company or a ground-based mobile communication network 20, it sends a call origination request signal to gateway switch processing function section 75. When mobile network control section 79 recognizes that gateway switch processing function section 75 has received a call origination request signal, it starts up mobile/satellite interface section 78 to transmit to mobile network interface section 81 of satellite entrance function section 80 a signal requesting connection of the satellite entrance line. When the satellite entrance control section 86, which monitors mobile network interface section 81, receives a connection request signal from mobile network interface section 81, it sends a connection request signal to communication satellite 61 through a signal processing section 82, signal isolation/synthesis section 85, transmission/receiving section 83 and satellite antenna section 84.

When ground-based satellite base station 62 receives a connection request signal relayed by communication satellite 61, it specifies a wireless channel of the satellite zone in accordance with the instructions from control section 64. After satellite entrance function section 80 has established synchronization of the designated wireless channel, it returns “satellite channel start-up completed” to ground-based satellite base station 62. Ground-based satellite base station 62 transmits a satellite line connection completion signal indicating that the satellite entrance zone has been started up normally. When satellite entrance function section 80 has received this satellite line connection completion signal it transfers a satellite line connection completion signal to gateway switch processing function section 75 through mobile network interface section 81. When gateway switch processing function section 75 recognizes that the satellite entrance zone has been started up normally, it sends a call origination request signal to satellite entrance function section 80. Satellite entrance function section 80 sends a call origination request signal to the POI using satellite entrance network 60. After the line connection procedure to the call-receiving party on mobile communication network 20a provided by other company, fixed communication network 20b provided by other company or ground-based mobile communication network 20 provided by the specified communication service provider, a calling signal indicating that the party to be connected is being called and the response signal indicating that this party has responded are transmitted through the POI, whereupon the response signal is notified to the mobile station 31 through satellite entrance network 60 and mobile communication network forming device 10. After this procedure, call service (communication) is commenced.

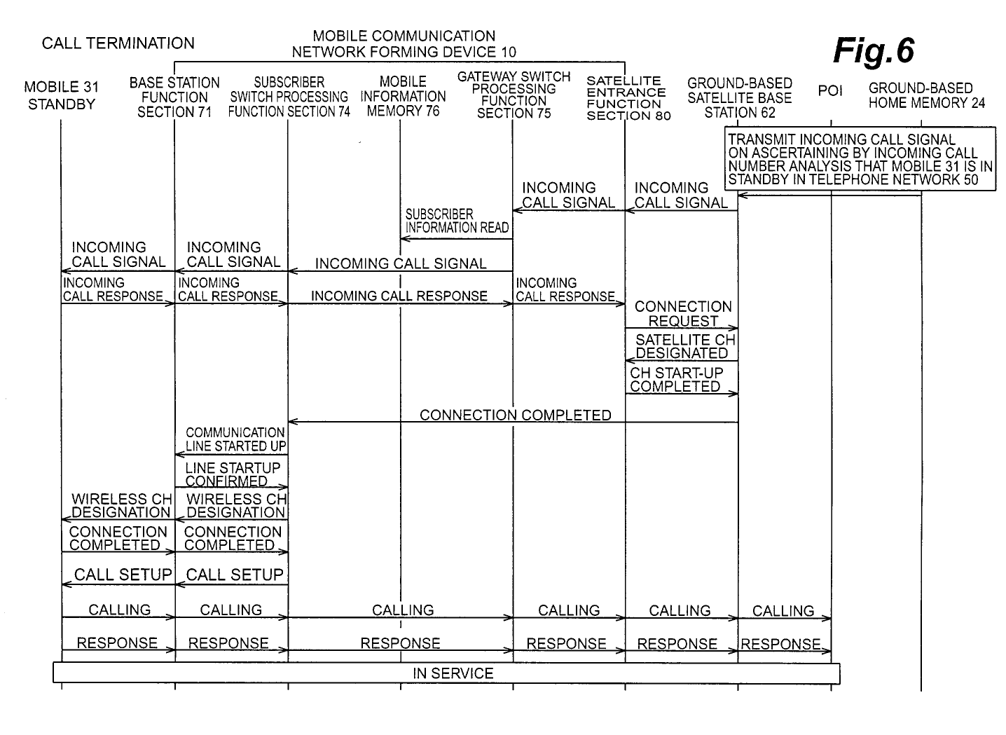

Next, a case where mobile station 30 under the control of mobile communication network 20a provided by other company, fixed communication network 20b provided by other company or ground-based mobile communication network 20 provided by the specified communication service provider has originated a call to mobile station 31 will be described. FIG. 6 is a sequence chart showing the operation relating to call termination. Upon receiving an incoming call signal, gateway exchange 23 of ground-based mobile communication network 20 recognizes that mobile station 31 is in range in local mobile telephone network 50 by referring to home memory 24. Gateway exchange 23 transfers an incoming call signal to ground-based satellite base station 62 through the POI. Ground-based satellite base station 62 sends an incoming call signal to satellite entrance function section 80 using a common channel.

Satellite entrance control section 86 transfers an incoming call signal to mobile communication network forming section 70 through mobile network interface section 81. Mobile network control section 79 transfers the incoming call signal received through mobile/satellite interface section 78 to gateway switch processing function section 75. After analyzing the incoming call signal, gateway switch processing function section 75 reads and checks the subscriber information corresponding to the incoming call number from mobile information memory 76 and transfers the incoming call signal to subscriber switch processing function section 74. Base station function section 71 sends the incoming call signal received from subscriber switch processing function section 74 to the wireless zone using the general calling channel.

Mobile station 31 sends an incoming call response indicating that it has received an incoming call and this incoming call response signal is sent to satellite entrance function section 80 through base station function section 71, subscriber switch processing function section 74, gateway switch processing function section 75 and mobile/satellite interface section 78. On receipt of the incoming call response, satellite entrance function section 80 starts up the satellite entrance line and establishes synchronization and notifies subscriber switch processing function section 74 of start-up of the satellite entrance line. After this, call set-up is performed by starting up the communication line in local mobile telephone network 50, designation of the wireless channel and notification of completion of the connection (the same procedure as in the case of the call origination sequence) and a call to the effect that the user is being called and a response signal indicating that the user has responded are sent to the call originating terminal through local mobile telephone network 50, satellite entrance network 60 and the POI. Service is then commenced.

If a control section and memory corresponding to home memory 24 are provided in ground-based satellite base station 62, it is possible for ground-based satellite base station 62 to be made to recognize that the in-range area of mobile station 31 is in local mobile telephone network 50.

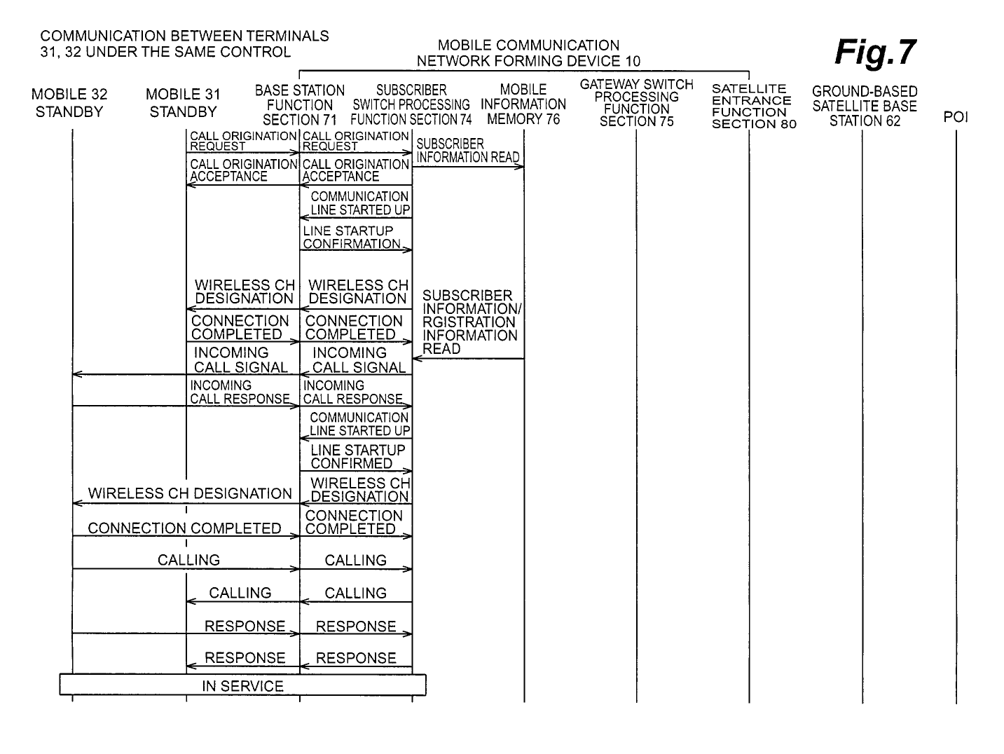

Next, the case will be described in which communication between terminals under the control of local mobile telephone network 50 formed by mobile communication network forming device 10 is performed. FIG. 7 is a sequence chart relating to communication between terminals under the control of local mobile telephone network 50. The case where mobile station 31 has originated a call to mobile station 32 will now be described. Upon receiving a call origination request, after reading and checking the subscriber information of mobile station 31, subscriber switch processing function section 74 returns the acceptance of call origination request to mobile station 31, and then starts up the communication line with mobile station 31. Subsequently, after recognizing that mobile station 32 which is the connection destination is under the control of local communication telephone network 50 by referring to the subscriber information and registration information, subscriber switch processing function section 74 transmits an incoming call signal to base station function section 71. Base function section 71 sends the incoming call signal for mobile station 32. Upon receiving an incoming call response sent by mobile station 32, subscriber switch processing function section 74 starts up the communication line with mobile station 32. Further, upon receiving a response signal indicating that the user has responded, subscriber switch processing function section 74 connects the communication line with mobile station 31 and the communication line with mobile station 32.

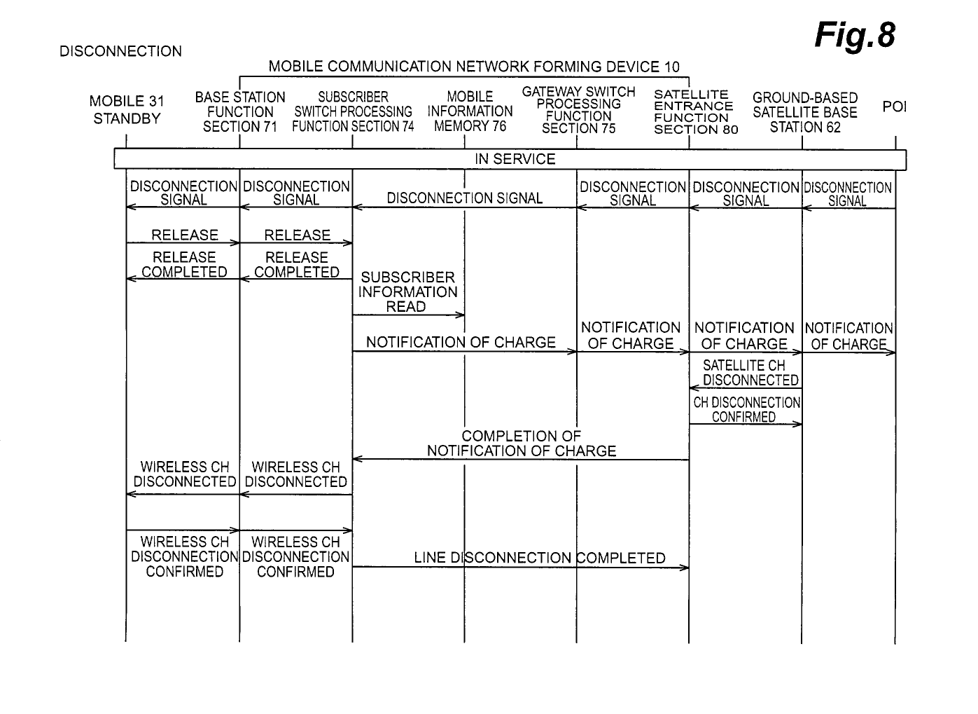

Next, disconnection and charging of a terminal under the control of local mobile telephone network 50 will be described. FIG. 8 is a sequence chart relating to disconnection processing and charging processing. When a disconnection request is generated from mobile communication network 20a provided by other company, fixed communication network 20b provided by other company or a terminal of ground-based mobile communication network 20 of the specified communication service provider which was communicating with mobile station 31 under the control of local mobile telephone network 50, a disconnection request signal is sent through satellite entrance network 60 and local mobile telephone network 50. Mobile station 31 sends a release signal to subscriber switch processing function section 74 in response to the disconnection signal. Completion of release is communicated to mobile station 31. Subscriber switch processing function section 74 stores information such as subscriber information indicating termination of communication and charging count in mobile information memory 76 and sends the charge information incurred in the present communication session to the home memory 24 nearest from ground-based satellite base station 62 through satellite entrance network 60, communication satellite 61, ground-based satellite base station 62 and the POI. If ground-based satellite base station 62 is provided with a memory and control section having the same functions as home memory 24, transmission may be effected to this memory.

After this, ground-based satellite base station 62 sends to satellite entrance function section 80 satellite channel disconnection signal indicating disconnection of the satellite line and, after satellite entrance function section 80 has sent channel disconnection confirmation and satellite line disconnection has been performed by satellite entrance control section 86, disconnection completion signal indicating completion of disconnection of the satellite entrance line is sent to gateway switch processing function section 75 and subscriber switch processing function section 74. After this, a wireless channel disconnection signal that disconnects the wireless line with mobile station 31 is sent to mobile station 31, causing mobile station 31 to transmit channel disconnection confirmation and perform line disconnection; completion of line disconnection is then notified to satellite entrance function section 80 from subscriber switch processing function section 74.

As described above, with the mobile communication system according to this embodiment of the present invention, since a base station function and subscriber switch function are provided, the mobile communication area is expanded and communication between mobile stations under the control of this device can be achieved without passing through the satellite entrance line. As a result, this device makes it possible to reduce the traffic volume generated on the satellite entrance line. Also, this device is provided with a satellite communication function and gateway switching function. Since, by means of it, a mobile station under the control of this device and other communication network is connected through satellite communication and wireless communication, a mobile communication service can be provided even in locations where wired connection between the base station and exchange is difficult. For example, areas where no mobile communications service is provided or areas around ships can be covered. Furthermore, since a local mobile communication network is formed, communication between mobile stations which are under the control of this device becomes possible and communication with other communication networks also becomes possible.

What is claimed is:

1. A mobile communication network forming device comprising:
a base station function section that forms a wireless zone;
subscriber switching means that perform connection exchange between mobile stations that are in range in said wireless zone and in-range management of mobile stations that are in range in said wireless zone; and
satellite gateway switching means that perform mutual connection between other communication network and a mobile station that is in range in said wireless zone through a communication satellite.

2. The mobile communication network forming device according to claim 1, wherein said satellite gateway switching means comprise:
satellite communication means that perform transmission/reception of signals with the communication satellite;
signal processing means that mutually convert signals transmitted to and received from said communication satellite and signals employed in said wireless zone; and
a gateway switching section that performs signal processing when mutual connection with said other communication network is performed.

3. The mobile communication network forming device according to claim 1, comprising storage means that store subscriber information and registration information of a mobile station which is in range in said wireless zone.

4. A mobile communication system including the mobile communication network forming device according to claim 1 and at least one mobile station.

5. A method of forming a mobile communication network comprising the steps of:
forming a wireless zone;
performing in-range management of mobile stations that are in range in said wireless zone and connection exchange between mobile stations that are in range in said wireless zone; and
performing mutual connection between other communication network and a mobile station that is in range in said wireless zone through a communication satellite.

6. The method of forming a mobile communication network according to claim 5, comprising the steps of:
performing transmission/reception of signals to/from a communication satellite;
mutually converting signals transmitted to and received from said communication satellite and signals employed in said wireless zone; and
performing signal processing when mutual connection with said other communication network is performed.

7. The method of forming a mobile communication network according to claim 5, comprising a step of storing subscriber information and registration information of mobile stations in range in said wireless zone.

8. A program for causing a computer to execute:
processing for forming a wireless zone;
processing for performing in-range management of mobile stations in range in said wireless zone and connection exchange between mobile stations in range in said wireless zone; and
processing for performing mutual connection between other communication network and a mobile station which is in range in said wireless zone through a communication satellite.

9. The program according to claim 8 for causing the computer the execution of:
processing for performing transmission/reception of signals to/from a communication satellite;
processing for mutually converting signals transmitted to and received from said communication satellite and signals employed in said wireless zone; and
processing of signals when mutual connection with said other communication network is performed.

10. The program according to claim 8 for causing the computer the execution of processing for storing subscriber information and registration information of mobile stations in range in said wireless zone.

11. A computer-readable storage medium on which the program according to claim 8 is recorded.

12. A method of forming a mobile communication network comprising:
a connection request acceptance step accepting from a mobile station in range of a wireless zone formed by a base station function section of a mobile communication network forming device a connection request for requesting connection with other communication terminal;
a in-range determination step determining whether said other communication terminal is in range of said wireless zone or not; and
a connection execution step executing the connection between said mobile station and said other communication terminal using a subscriber switching means in case said other communication terminal is determined to be in range of said wireless zone in said in-range determination step, and executing the mutual connection between said mobile station and other communication network via a communication satellite in case said other communication terminal is determined to be not in range of said wireless zone in said in-range determination step.

13. The method of forming a mobile communication network according to claim 12, wherein the determination of said in-range determination step is carried out by referring to registration information and subscriber information stored in storage means.

14. A program for causing a computer to execute the method of forming a mobile communication network according to claim 12.

15. A computer-readable storage medium on which the program according to claim 14 is recorded.
